(19) United States
(12) Patent Application Publication
(10) Pub. No.: US 2009/0322244 A1
(43) Pub. Date: Dec. 31, 2009

(54) PIEZOELECTRIC TRANSFORMER LIGHT ADJUSTING NOISE REDUCTION CIRCUIT

(76) Inventors: Seiji Namiki, Saitama (JP); Yasuhiro Yokote, Saitama (JP); Minoru Yamada, Saitama (JP); Akira Mizutani, Saitama (JP); Atsushi Shimbo, Saitama (JP)

Correspondence Address: SNELL & WILMER LLP (OC), 600 ANTON BOULEVARD, SUITE 1400, COSTA MESA, CA, 92626, US

(21) Appl. No.: 12/307,105

(22) PCT Filed: Jul. 20, 2007
(86) PCT No.: PCT/JP07/00780

§ 371 Date: Feb. 27, 2009

(30) Foreign Application Priority Data
Jul. 26, 2006 (JP) 2006-203880

(51) Int. Cl. H05B 41/285

(52) U.S. Cl. 315/279

(57) ABSTRACT

Provided is a light adjusting noise reduction circuit in which the vibration noise accompanying turning ON/OFF of a piezoelectric transformer. A full bridge circuit is controlled by a full bridge drive circuit so as to switch an input voltage (VB1) from an input voltage source and outputs it to a low pass filter. The output from the low pass filter is supplied to a piezoelectric transformer. The output current (IO) from the piezoelectric transformer is supplied to a discharge tube. Each of FET of the full bridge circuit has a drive frequency decided by a voltage control type oscillator. The full bridge circuit is connected to a duty variable circuit and a peak value control circuit. The peak value control circuit forms a rise and a fall of a waveform to be (1−cosωt).

### TECHNICAL FIELD

The present invention relates to a piezoelectric transformer noise reduction circuit for a lighting/light adjusting circuit of a discharge tube (e.g., a cold cathode fluorescent tube) used as a backlight of a liquid crystal display and the like, and particularly relates to [a piezoelectric transformer noise reduction circuit] which is configured to reduce oscillation noise and improve brightness fluctuation by controlling a peak value of output voltage of a full bridge circuit so that a rising waveform and falling waveform of the output voltage form a cosine curve.

### BACKGROUND

Burst light adjustment for repeatedly turning a cold cathode fluorescent tube on and off by using a piezoelectric transformer has conventionally been known as a cold cathode fluorescent tube light adjustment system. Since the piezoelectric transformer uses oscillation by a piezoelectric effect when performing this burst light adjustment, an oscillation occurs in a repetition frequency or harmonic [of the cold cathode fluorescent tube]. This oscillation is transmitted to a circuit board or the like equipped with the piezoelectric transformer and consequently causes an audible sound. The frequency of this sound generated by the oscillation is either the same as the repetition frequency obtained as a result of turning [the cold cathode fluorescent tube] on and off or a component of the harmonic. The repetition frequency of the [the cold cathode fluorescent tube] turned on and off is generally several tens to a hundred hertz, hence a sound of several tens to several hundreds hertz is generated. The sound in this frequency domain could be a harsh sound to sensitive human ears.

Specifically, in the conventional burst light adjustment, electric power shown in FIG. 7(a) (illustrated in the form of effective power) is applied to the piezoelectric transformer in order to repeatedly turn the discharge tube on and off. Therefore, the piezoelectric transformer generates oscillations in the form of the envelope curves shown in FIG. 7(b). In other words, [the piezoelectric transformer] oscillates at a drive frequency when turning [the discharge tube] on and stops oscillating when turning off. Transiently large electric power shown in FIG. 7(a) is required to suddenly start or stop the oscillation, but a transient abnormal oscillation occurs as shown in FIG. 7(b), which is considered the source of the generated sound.

In view of this aspect, a piezoelectric transformer light adjusting noise reduction circuit has conventionally been proposed as described in, for example, Patent Literature 1 and Patent Literature 2. Specifically, these conventional technologies are used for performing burst light adjustment without stopping a oscillation of the piezoelectric transformer and are capable of supplying to the discharge tube a current that repeats amplitudes of two values by repeating large and small oscillation amplitudes in accordance with the cycle for performing the burst light adjustment, while continuing the oscillation of the piezoelectric transformation even in the cycle for turning [the discharge tube] off.

FIG. 8 shows the operation of the circuits described in these patent literatures, wherein FIG. 8(a) shows the time-shared electric power driving the piezoelectric transformer, while FIG. 8(b) shows envelope curves of the oscillation amplitudes of the piezoelectric transformer that are obtained when [the electric power is time-shared]. The electric power represented by the vertical axis of FIG. 8(a) is the effective power. In FIG. 8(a) the piezoelectric transformer is repeatedly applied with large electric power (to be referred to as “high electric power” herein) and small electric power (to be referred to as “low electric power”) alternately in time-sharing. Time intervals in which the high electric power and low electric power are applied are denoted by “m” and “n” respectively. The sum of m and n represents a repetition period. The brightness of the discharge tube can be adjusted by changing the ratio between these two time intervals (time sharing ratio=n/(m+n)) or changing at least one of these two electric powers.

Patent Literature 1: Japanese Patent Application Publication No. 2000-58289

Patent Literature 2: Japanese Patent Application Publication No. 2000-223297

However, in the inventions of Patent Literature 1 and Patent Literature 2, the low electric power is supplied to the cold cathode fluorescent tube even during a light adjustment OFF period, the problem is that fluctuation occurs in brightness of a liquid crystal display in which this type of cold cathode fluorescent tube is used. Especially on a large screen such as a liquid crystal display, only the both ends of the fluorescent tube are turned on even during the OFF period, making it difficult to control the degree of light adjustment uniformly over the entire screen.

This aspect is described specifically with a conventional light adjusting circuit of FIG. 9 that is proposed by the present applicant and a time chart of FIG. 10 that shows output voltage or output current of each component [of the light adjusting circuit]. Note that the light adjusting circuit shown in FIG. 9 is described in the present specification to explain the present invention and is not heretofore known at the time of filing of the present application.

In the light adjusting circuit shown in FIG. 9, a full bridge circuit 2 connected to the output side of an input voltage source 1 is applied with a supply voltage VIN from the input voltage source 1 as an input voltage VB1 directly, and then the full bridge circuit 2 switches this input voltage VB1.

An output VFO from the bridge circuit 2 is output to a piezoelectric transformer 4 via a low-pass filter 3, and then an output IO of the piezoelectric transformer 4 is supplied to a discharge tube, such as a backlight. Specifically, the piezoelectric transformer 4 converts an electric signal to a mechanical oscillation and then converts it back to an electric signal. In this circuit an AC voltage (brief sine wave) from the low-pass filter is converted to a high voltage to turn on a discharge tube which is a load.

The low-pass filter 3 attenuates the harmonic component out of the output waveforms of the full bridge circuit 2, whereby a fundamental wave component of the full bridge circuit 2 can be applied to the piezoelectric transformer 4. Note that ideally the piezoelectric transformer 4 is driven by sine wave, and since the harmonic component is either converted to heat or reflected to the input side, the harmonic component needs to be attenuated by the low-pass filter 3.

The full bridge circuit 2 is provided with a full bridge drive circuit 5, an interface circuit for driving the full bridge circuit 2. This full bridge drive circuit 5 drives each of FET of the full bridge [circuit 2] to convert an output voltage of the full bridge circuit 2 under conditions of a voltage control type oscillator 9 and duty variable circuit 6 described hereinafter. The duty variable circuit 6 connected to the full bridge drive circuit 5 outputs a duty signal proportional to an output Vd of trapezoidal wave generator 10 to the full bridge drive circuit 5.

A current/voltage conversion circuit 7 for converting a load current acquired from the output side of the piezoelectric transformer 4 to a voltage, an integrator 8 incorporated with a reference voltage, and the voltage control type oscillator 9 are connected to the input side of the duty variable circuit 6.

The current/voltage conversion circuit 7 detects a current IO flowing in a load (cold cathode tube) and converts it to a voltage value to create a DC voltage VIV proportional to the load current and then returns [the DC voltage VIV] to the integrator 8 as load current information.

The integrator 8 integrates a differential voltage between thus obtained voltage-converted value VIV of the load current IO and the reference voltage incorporated in [the integrator 8], by time. Therefore, if the VIV is less than the reference voltage, an integrator output Vint changes with time. When VIV=reference voltage is established, the differential voltage becomes zero and the integration output Vint becomes a constant value without changing with time. Therefore, the Vint that is obtained when VIV=reference voltage is established is continuously output. In this circuit, it is assumed that the integrator output Vint is set at an increasing polarity when VIV is less than the reference voltage. Moreover, [this circuit] is initialized by turning the power of an inverter on, and Vint=0v is established immediately after the operation [of this circuit] is started.

The oscillating frequency of the voltage control type oscillator 9 is determined based on the integrator output Vint. Specifically, as shown in FIG. 11, when Vint=0, the frequency of this oscillator is set at a frequency that is sufficiently higher than a resonance frequency of the piezoelectric transformer. When the value of Vint increases the frequency of this oscillator is set so as to decrease in accordance with the increase of the voltage [of the Vint]. Furthermore, the oscillator is configured so as to be able to output a frequency that is sufficiently close to or lower than the resonance frequency of the piezoelectric transformer, when the value of the voltage of the Vint is at the maximum possible value. Therefore, when the VIV becomes the reference voltage incorporated in the integrator, Vint=const (this does not change with time) is established, and consequently the oscillator starts oscillating at a constant frequency. Such a state is the state of stable operation.

As described above, in this circuit the current/voltage conversion circuit 7 detects the output current I0 output from the piezoelectric transformer 4, then the integrator 8 integrates thus obtained output VIV, thereafter the voltage control type oscillator 9 is driven based on thus obtained output Vint, and then thus obtained output OSC is fed back to the full bridge circuit 2 via the duty variable circuit 6 and the full bridge drive circuit 5, thereby controlling an operating frequency of the full bridge circuit 2.

A rectangular wave Vdm, a light adjusting signal of the discharge tube, is supplied to the duty variable circuit 6 via the trapezoidal wave generator 10, and then the duty variable circuit 6 is driven over a High period (a period during which the output current is output; same hereinafter) of the output signal Vd from the trapezoidal wave generator 10. Specifically, the output of the trapezoidal wave generator 10 is input to the duty variable circuit 6 and gently changes the duty cycle of the full bridge. This is performed for the purpose of reducing the noise generated during light adjustment by smoothening the rise and fall of the output current that occur as a result of light adjustment. Note that the noise increases when the output current rises and falls steeply as a result of the light adjustment.

On the other hand, the light adjusting signal Vdm controls the duty of the full bridge circuit 2 in accordance with the length of the High period [of the light adjusting signal Vdm] to determine the degree of light adjustment of the discharge tube. This light adjusting signal Vdm is input in the form of a GATE signal to the integrator via a rise delay circuit 11, and then the integrator 8 is activated only during the High period of this GATE signal. Note that the integrator 8 halts its operation during a Low period of the GATE signal and holds its output immediately before the halt.

Specifically, during the High period of the light adjusting signal, the rise delay circuit 11 delays a certain period of the beginning of [the High period] and outputs a signal of thus obtained LOW [period]. This certain period is a transient response [period] of the rise of the output current or a period of soft starting performed by the duty variable circuit 6 and indicates an unstable value of the output current, and hence the operation of the integrator 8 is prohibited [during this period]. The rise delay circuit 11 inputs to a GATE terminal of the integrator 8. Due to the delay made by the rise delay circuit 11, the integrator 8 is controlled not to integrate the unstable part of the output current.

Similarly, because the rise delay circuit 11 outputs a Low signal even when the light adjusting signal is low, the region where the output is set at 0 due to light adjustment is not integrated. If the region where the output current is set at 0 due to light adjustment is integrated, the output of the integrator increases and the drive frequency of the piezoelectric transformer 4 approaches the resonance frequency. As a result, the output current obtained during the High period of the light adjusting signal increases, damaging the light adjusting function and causing life reduction and reduction of the cold cathode fluorescent tube.

In the light adjusting circuit with such a configuration as shown in FIG. 9 is provided with the trapezoidal wave generator 10 so as to smoothen the rise and fall of the duty of the full bridge circuit 2, gently change the peak values of the rise and fall of the output current IO, and to consequently reduce the noise generated during light adjustment. In actuality, however, sufficient noise control could not be performed due to the following problems.

(1) Impacts of Sideband Wave

In the abovementioned light adjusting circuit, when the duty approaches 0, the harmonic component increases and the noise generated during light adjustment increases. It is considered accordingly that this harmonic component affects the oscillation of the piezoelectric transformer, increasing the noise generated during light adjustment. More specifically, light adjustment performed by the inverter adjusts the amount of light of the discharge tube by interrupting the output current having the drive frequency of the piezoelectric transformer (output frequency of the inverter) at a low frequency (150 Hz, in this case) and changing the on-duty [of the output current].

The waveform of the output current in this case is the same as [the waveform] that is amplitude-modulated at 150 Hz. However, due to the steep rising and falling parts of the waveform, [the waveform] is amplitude-modulated at the harmonic of 150 Hz. As a result, noise spectrum is expressed in a frequency corresponding to a carrier wave of 52 kHz and a frequency called “sideband wave” that is generated at the interval of 150 Hz.

It is considered that the noise expressed in this spectrum is generated at the moment the current rises or falls as a result of light adjustment. Without a frequency point that resonates with a system between the piezoelectric transformer, the generation source, and human ears, the sideband wave within an audible bandwidth is attenuated, and therefore a low noise level is obtained due to the attenuation. On the other hand, if there is a frequency point that resonates with the system between the generation source and the human ear, the sideband wave is amplified at this frequency and the noise level increases. Now, if there is a frequency point that resonates at 7 kHz, the sideband wave corresponding to the frequency of 7 kHz is amplified, then a sound wave having a frequency of 7 kHz is amplified every time the light adjustment is ON/OFF, and [the obtained sound wave] is generated.

According to this circumstance, the noise-generating mechanism is similar to “beating a tuning fork having a frequency of 7 kHz with a hammer as the light adjustment is turned ON/OFF.” The strength to beat with the hammer can be expressed in the level of the sideband wave corresponding to the frequency of 7 kHz, and the resonance frequency of the tuning fork corresponds to the resonance frequency of the system. The number of hammerings corresponds to the number of times the light adjustment is turned ON/OFF.

(2) Disturbance in the fall of the light adjusting waveform . . . Increase in noise due to a discontinuity in the waveform

A method considered in order to avoid the impacts of the harmonic described in (1) above is a method of setting the duty of a full bridge output at 0 when the duty of the full bridge is reduced to some extent (approximately 30%). When this method is adopted, the waveform of the output current becomes discontinuous at the moment the duty of the full bridge output becomes zero. Such a discontinuity causes a disturbance on the waveform, increases the sideband wave of the audible bandwidth, and increases the light adjusting noise.

Specifically, when the drive frequency of the full bridge circuit 2 controlled by the output OSC of the voltage control type oscillator 9 is, for example, 52 kHz, the piezoelectric transformer 4 oscillates at 52 kHz during its operation. However, when the duty of the full bridge output becomes zero the piezoelectric transformer 4 oscillates at its resonance frequency of, for example, 50 kHz. This change occurs at a timing at which [the voltage obtained when the piezoelectric transformer 4] is driven is switched to 0V regardless of the phase of the driving frequency. As a result, the phase becomes discontinuous.

(3) When gently changing the duty of the full bridge circuit

In order to eliminate the impacts of the sideband wave, it is necessary to sufficiently smoothen the rise and fall of the waveform as well as the peak value of the output current, as shown in FIG. 11, so that the light adjusting noise is reduced. In this case, however, the time period during which [the waveform of] the output current is flat is short and consequently the time period during which a predetermined value of a tube current can be secured is short. As a result, the brightness of the screen starts fluctuating, which limits the light adjusting range.

Specifically, although the noise is not reduced by smoothening the light adjusting waveform, the time period during which the light adjustment is ON is shortened and thereby the discharge tube is turned in a state in which sufficient current is not sent (unstable state). Therefore, not only unstable light adjustment is performed, but also brightness fluctuation occurs and the light adjusting range is limited.

(4) Problems in Constant Drive

As described in the inventions of the abovementioned Patent Literature 1 and Patent Literature 2, considered is a method of eliminating the phase discontinuity caused by the difference between a drive frequency and a self-resonance frequency, by constantly driving the piezoelectric transformer. In this case, however, because low electric power is supplied to the cold cathode fluorescent tube even during the OFF period of light adjustment, the problem of brightness fluctuation occurs on a liquid crystal display in which this type of cold cathode fluorescent tube.

### DISCLOSURE OF THE INVENTION

The present invention has been contrived to solve these problems of the conventional technologies described above, and an object of the present invention is to provide a piezoelectric transformer light adjusting noise reduction circuit that is capable of reducing oscillation noise caused when a piezoelectric transformer is turned ON/OFF and at the same time preventing a brightness fluctuation in a liquid crystal display that uses a discharge tube.

In order to achieve the above object, the present invention is characterized in adopting the following configurations in a piezoelectric transformer light adjusting noise reduction circuit, which has a full bridge circuit that is activated by receiving an output voltage from an input voltage source, and a piezoelectric transformer that is supplied with an output from the full bridge circuit, and in which an output current of the piezoelectric transformer is supplied to a discharge tube.

(1) A full bridge drive circuit activated while feeding back a current flowing in a load is connected to the full bridge circuit.

(2) A duty variable circuit that controls an output voltage output from the full bridge circuit is provided to either the full bridge circuit or full bridge drive circuit.

(3) A peak value control circuit that controls a rising waveform and falling waveform of the output voltage of the full bridge circuit when a light adjusting signal rises and falls is connected to the duty variable circuit.

(4) The peak value control circuit controls a peak value of the output voltage of the full bridge circuit so that the rising waveform and falling waveform of the output voltage form cosine curves.

Furthermore, another aspect of the present invention includes the following configurations.

(a) An output of the peak value control circuit is connected to the duty variable circuit, and the full bridge drive circuit controls a duty of the full bridge circuit based on an output from the duty variable circuit.

(b) The full bridge circuit is configured to have a fixed duty, and there is provided between the input voltage source and the full bridge circuit a chopping circuit that turns an output from the input voltage source ON/OFF in a predetermined cycle and changes an input voltage of the full bridge circuit, and the duty variable circuit that controls a duty [of the chopping circuit] and changes the output voltage is connected to the chopping circuit.

(c) The full bridge drive circuit is connected to a current/voltage conversion circuit for detecting the current flowing in the load and converting the same to a voltage value, an integrator for comparing a load current acquired by the current/voltage conversion circuit with a reference voltage incorporated [in the integrator], and to a voltage control type oscillator for determining an oscillating frequency based on an output from the integrator, and wherein an output from the voltage control type oscillator is fed back to the full bridge circuit via the full bridge drive circuit to control an operating frequency of the full bridge circuit.

(d) The integrator is provided with a rise delay circuit for prohibiting the operation of the integrator in order to secure a transient response of a rise of the output current and a period during which the duty variable circuit soft-starts the chopping circuit.

According to the present invention, by controlling the peak value of the output voltage of the full bridge circuit so that the rising waveform and falling waveform of the output voltage form cosine curves, the level of a sideband wave that falls within the audible bandwidth can be reduced when a light adjusting waveform rises and falls, and consequently the occurrence of the light adjusting noise can be reduced.

Moreover, according to the aspect of (c) of the present invention, not only is it possible to achieve the above effects, but also it is possible to reduce the occurrences of the light adjusting noise caused by a phase discontinuity and bright fluctuation caused by driving the piezoelectric transformer during both ON/OFF periods thereof, by driving the piezoelectric transformer during its ON period and OFF period and simultaneously stopping the supply of current to the piezoelectric transformer during its OFF period.

### BRIEF DESCRIPTION OF THE DRAWINGS

FIG. 1 is a block diagram showing a configuration of a first embodiment of the present invention.

FIG. 2 is a time chart showing the detail of an operation of a peak value control circuit according to the first embodiment.

FIG. 3 is a time chart showing an output waveform of each component according to the first embodiment.

FIG. 4 is a block diagram showing a configuration of a second embodiment of the present invention.

FIG. 5 is a time chart showing the detail of an operation of a peak value control circuit according to the second embodiment.

FIG. 6 is a time chart showing an output waveform of each component according to the second embodiment.

FIG. 7 is a time chart showing an input voltage and oscillation of a piezoelectric transformer of a conventional light adjusting circuit.

FIG. 8 is a time chart showing an input voltage and oscillation of a piezoelectric transformer of a light adjusting circuit described in each of Patent Literature 1 and Patent Literature 2.

FIG. 9 is a block diagram showing a configuration of the conventional light adjusting circuit by the present applicant.

FIG. 10 is a time chart showing an output waveform of each component of the light adjusting circuit shown in FIG. 9.

FIG. 11 is a graph showing the resonance characteristics of a piezoelectric transformer of the light adjusting circuit shown in FIG. 9.

FIG. 12 shows a time chart showing a waveform of an output voltage of a full bridge drive circuit of the light adjusting circuit shown in FIG. 9 and a graph showing a mechanism for generating a sideband wave in an audible band.

FIG. 13 is a time chart for explaining the problems that occur when smoothening the changes in a duty of the full bridge circuit of the conventional light adjusting circuit.

1 . . . Input voltage source

2 . . . Full bridge circuit

3 . . . Low-pass filter

4 . . . Piezoelectric transformer

5 . . . Full bridge drive circuit

6 . . . Duty variable circuit

7 . . . Current/voltage conversion circuit

8 . . . Integrator

9 . . . Voltage control type oscillator

10 . . . Trapezoidal wave generator

11 . . . Rise delay circuit

21 . . . Chopping circuit

22 . . . Peak value control circuit

### BEST MODE FOR CARRYING OUT THE INVENTION

(1) Configuration of the First Embodiment

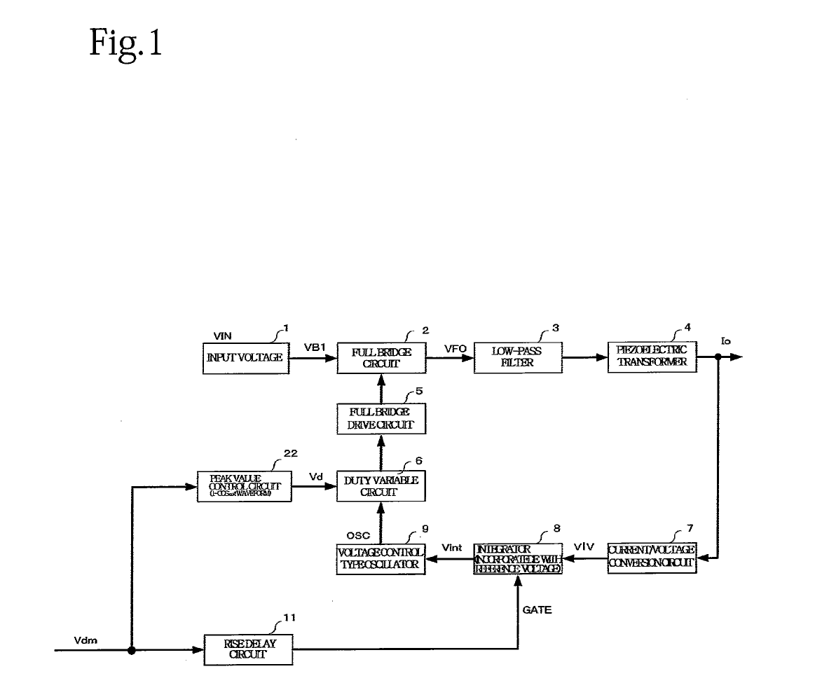

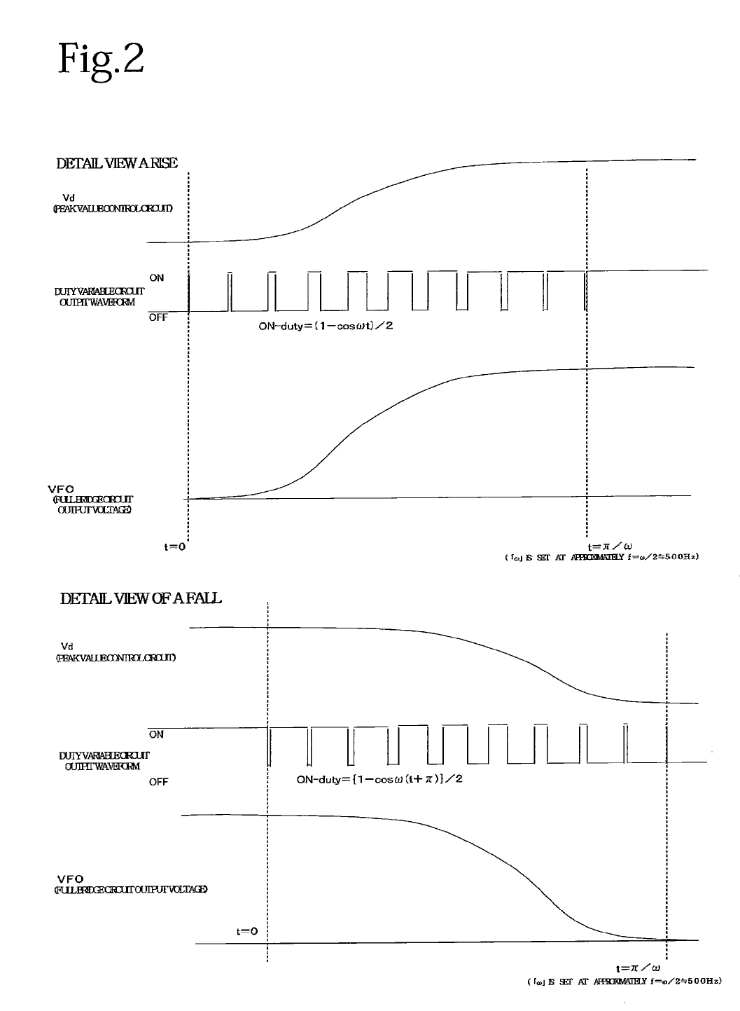

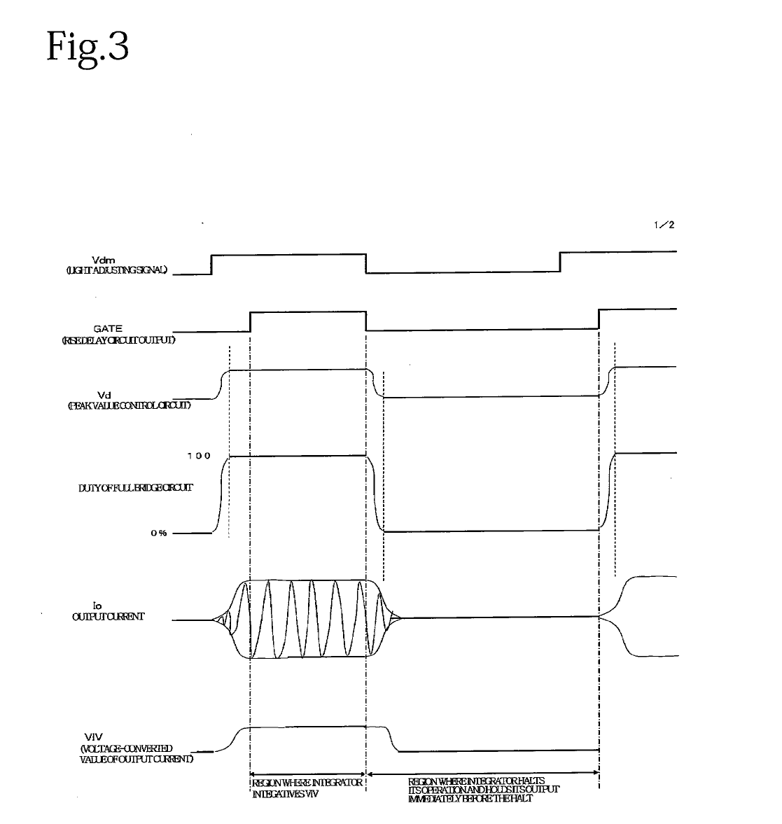

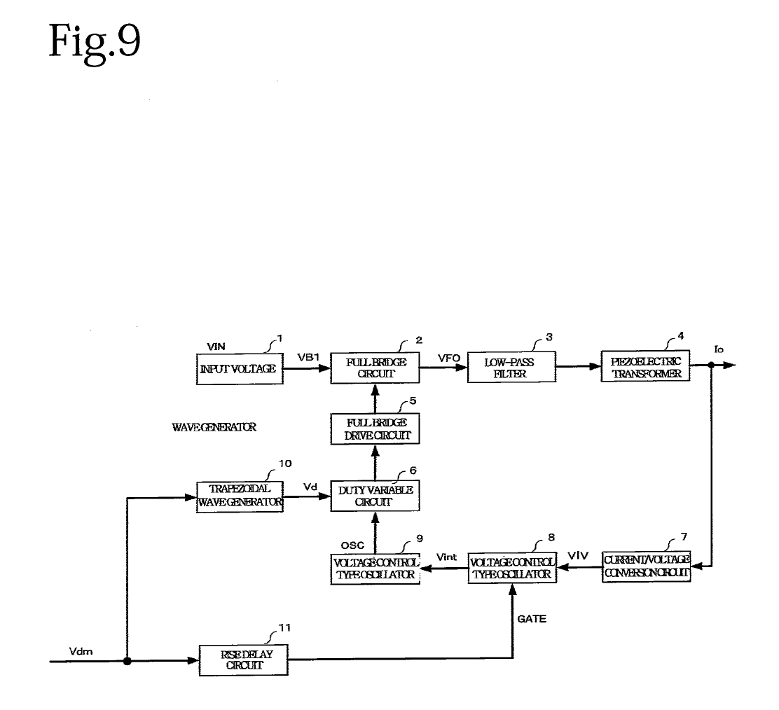

Hereinafter, the first embodiment of the present invention is described specifically with reference to the functional block diagram of FIG. 1 and the time charts of FIG. 2 and FIG. 3. According to the first embodiment, the present invention is applied to the light adjusting circuit shown in FIG. 9, and like reference numerals are used to designate the components same as those of the light adjusting circuit shown in FIG. 9, and therefore their explanations are omitted.

In the present embodiment, a peak value control circuit 22 is provided in place of a trapezoidal wave generator 10 in the light adjusting circuit shown in FIG. 9. This peak value control circuit 22 is to determine the form of a peak value that is the most effective in reducing light adjusting noise, and outputs a waveform of in which a waveform of (1−cosωt) is formed in rising and falling sections of an output voltage Vd.

As a result, a rectangular waveform Vdm, a light adjusting signal of a discharge tube, is supplied to the duty variable circuit 6 via the peak value control circuit 22, and the duty variable circuit 6 is driven over a High period (a period during which an output current is output; same hereinafter) of the output signal Vd from the peak value control circuit 22.

Specifically, as shown in FIG. 2, in the duty variable circuit 6 to which the output voltage Vd having the (1−cosωt) waveform is applied, when the following conditions are set:

(1) Beginning of the rise (fall) of the waveform t=0

(2) End of the rise (fall) t=π/ω

(3) ON-duty=(1−cosωt)/2

(4) f=ω/2π, where ω is approximately 500 Hz, a rectangular waveform having a long ON period is output from the duty variable circuit 6 as the output voltage Vd sent from the peak value control circuit 22 increases.

Note that the output waveform of the duty variable circuit 6 shown in FIG. 2 is a schematic figure, and an actual circuit is turned ON/OFF at a high frequency of approximately 50 kHz. Therefore, when ω/2π(=f) is 500 Hz, [the duty variable circuit 6] is turned ON/OFF fifty times. In FIG. 2, the number of times [the duty variable circuit 6] is turned ON/OFF is ten, for convenience of expression.

(2) Operations of the First Embodiment

In the first embodiment with the above configuration, the rising and falling waveforms of the output voltage of the full bridge circuit 2 can be smoothened into cosine curves by means of the duty variable circuit 6 and the full bridge drive circuit 7 by providing the peak value control circuit 22. As a result, peak values of rise and fall of an output current IO can be changed gently, and noise generated during light adjustment can be reduced.

Specifically, in the present embodiment, the rise and fall of the light adjusting waveform can be formed into (1−cosωt) waveforms by means of the peak value control circuit 22 so that the level of a sideband wave of an audible band can be reduced. Note that, according to the experiment performed by the applicant, when the (1−cosωt) rising and falling waveforms of the light adjusting waveform having a frequency of 500 Hz was compared with a waveform having a charge-discharge curve, it was confirmed that the level of the sideband wave of approximately 36 dB was reduced in the audible bandwidth.

(3) Configuration of the Second Embodiment

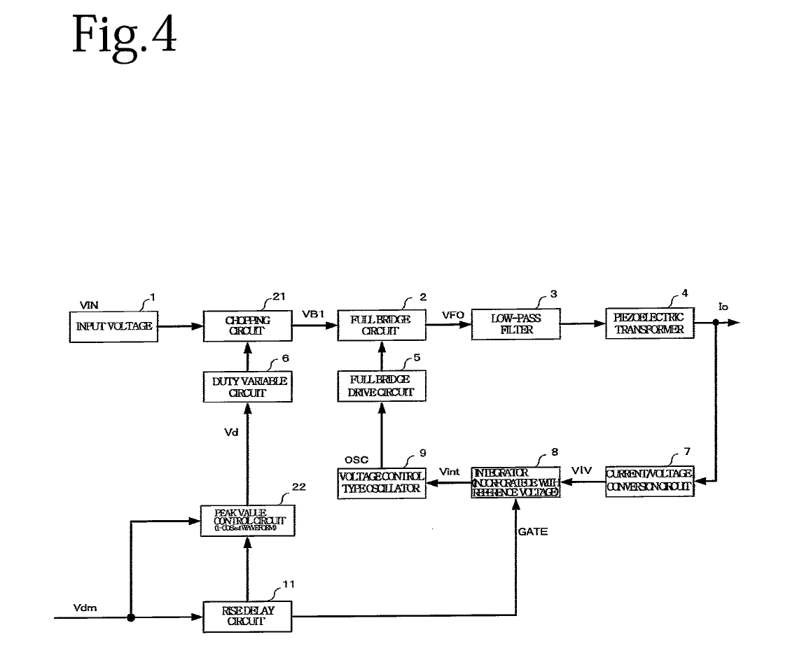

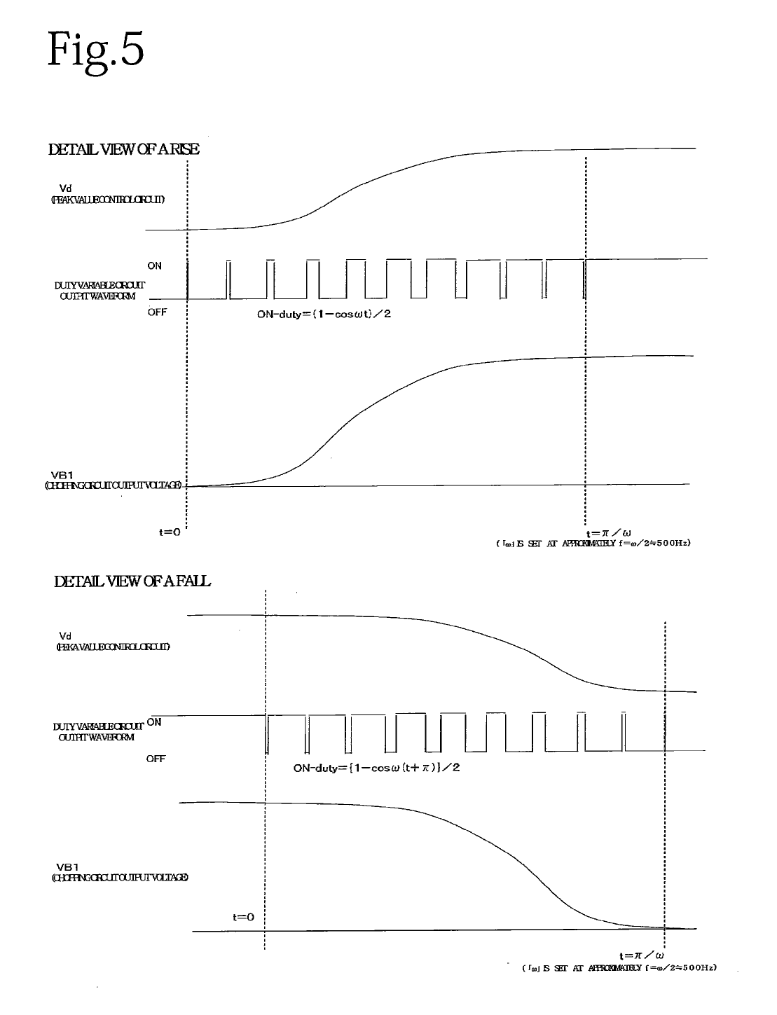

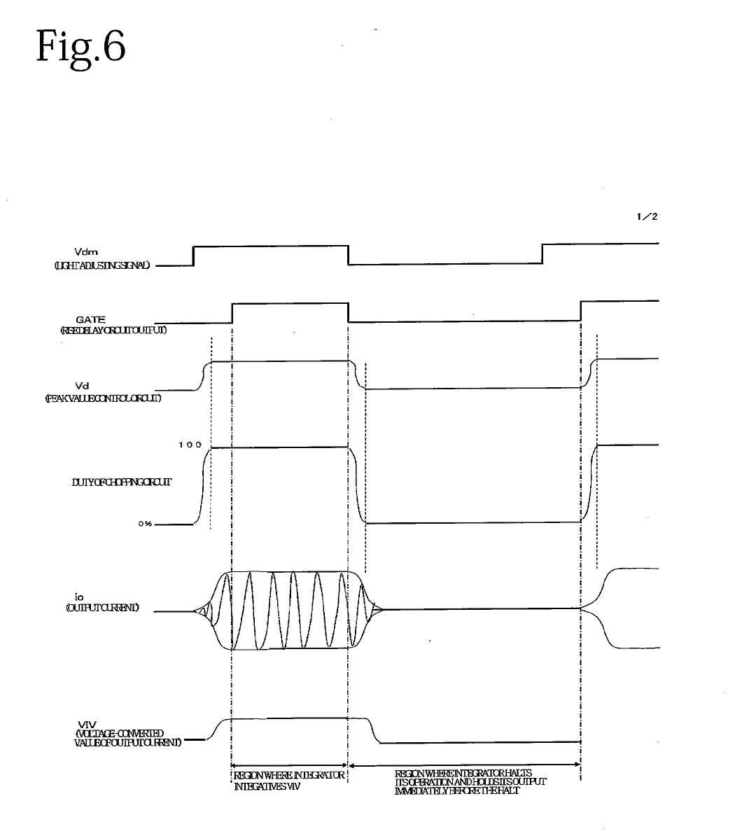

Hereinafter,. the second embodiment of the present invention is described specifically with reference to the functional block diagram of FIG. 4 and the time charts of FIG. 5 and FIG. 6. Note that like reference numerals are used to designate the components same as those of the light adjusting circuit shown in FIG. 9, and therefore their explanations are omitted.

The circuit of the present embodiment has a chopping circuit 21 for turning the output from the input voltage source 1 ON/OF in a predetermined cycle, the full bridge circuit 2 that is activated by an output voltage VB1 of the chopping circuit 21, and the low-pass filter 3 for removing a harmonic component contained in an output voltage VFO of the full bridge circuit 2, wherein an output from the low-pass filter 3 is supplied to the piezoelectric transformer 4 and the output voltage IO of the piezoelectric transformer 4 is supplied to the discharge tube.

The full bridge circuit 2 of the present embodiment is controlled by a full bridge drive circuit 5 and switches the input voltage VB1 sent from the chopping circuit 21. A drive frequency of each FET of the full bride circuit 2 is determined by a voltage control type oscillator 9. Because the duty variable circuit 6 is connected to the chopping circuit 21, the duty of the full bridge circuit 2 is fixedly operated.

The integrator 8 driving the voltage control type oscillator 9 and the current/voltage conversion circuit 7 have the same configuration as those of the conventional technology and the first embodiment, but the difference is that the voltage control type oscillator 9 supplies a switching frequency to the full bridge circuit 2, not via the duty variable circuit 6, but directly via the full bridge drive circuit 5.

The chopping circuit 21 described above aims to change the input voltage of the full bridge circuit 2. The output voltage VB1 of the chopping circuit 21 is controlled by an output of the duty variable circuit 6. Specifically, the duty variable circuit 6 is connected to the full bridge drive circuit 5 in the conventional technology or the first embodiment, but it is connected to the chopping circuit 21 in the second embodiment.

A light adjusting signal Vdm is supplied to the duty variable circuit 6 via the peak value control circuit 22. The peak value control circuit 22 controls rising and falling waveforms of an output voltage of the chopping circuit 21 that are obtained when the light adjusting signal Vdm rises and falls. Specifically, an output Vd of the peak value control circuit 22 is input to the duty variable circuit 6, controls a duty of the chopping circuit 21 and change the output voltage of the chopping circuit 21.

The peak value control circuit 22 is to determine the form of a peak value that is the most effective in reducing light adjusting noise. In the present embodiment, the peak value control circuit 22 outputs a waveform in which a waveform of (1−cosωt) is formed in rising and falling sections of the output voltage Vd.

Note that FIG. 5 shows an output waveform obtained from the peak value control circuit 22 of the second embodiment, and the basic shape [of the output waveform] is the same as the one shown in FIG. 2 of the first embodiment. However, although the peak value control circuit 22 controls the duty of the full bridge circuit 2 in the first embodiment, the difference [between the first and second embodiments] is that [the peak value control circuit 22] controls the duty of the chopping circuit 21 in the second embodiment.

An output voltage having the (1−cosωt) waveform is obtained from the chopping circuit 21 driven by the rectangular wave of the duty variable circuit 6, as shown in the VB1 in FIG. 5, whereby the full bridge circuit 2 is driven. In this case, when the output of the duty variable circuit 6 is ON the chopping circuit 21 is switched ON, and the output voltage of the chopping circuit 21 increases (or decreases) in proportional to ON-duty of the duty variable circuit 6.

Moreover, in the present embodiment, as with the conventional technology, during the High period of the light adjusting signal (a period during which the output current is output), a rise delay circuit 11 delays a certain period of the beginning of this period and outputs a signal of thus obtained LOW [period]. This certain period is a transient response [period] of the rise of the output current or a period during which the duty variable circuit 6 soft-starts the chopping circuit 21, and indicates an unstable value of the output current, hence the operation of the integrator 8 is prohibited [during this period].

(4) Operations of the Second Embodiment

In the second embodiment with the above configuration, because the full bridge circuit 2 has a fixed duty, it can apply a voltage having a small number of harmonic components to the piezoelectric transformer 4 in the entire region. Specifically, the full bridge circuit 2 can be driven over the entire period as described in Patent Literature 1 and Patent Literature 2 and has an advantage of not generating the phase discontinuity that is caused by turning ON/OFF [the piezoelectric transformer 4]. Note that, according to the experiment performed by the applicant, it was confirmed that the level of the sideband wave of approximately 24 dB was reduced in the audible bandwidth by securing a phase continuity. As a result, according to the present embodiment, not only is it possible to achieve the effect of forming the rising and falling [waveforms] of the output voltage of the full bridge circuit into cosine curves, but also it is possible to reduce 60 dB noise.

Moreover, because the chopping circuit 21 prevents a current from being supplied from the input voltage source 1 to the full bridge circuit 2 during the OFF period of the light adjusting signal, the output current IO [of the piezoelectric transformer 4] becomes “0” during the OFF period of the light adjusting [signal] while the piezoelectric transformer 4 is driven over the entire period, and consequently no current is supplied to the discharge tube. As a result, the phase continuity can be secured by driving [the piezoelectric transformer 4] over the entire period to reduce noise, and also the discharge tube is prevented from being lit during the OFF period of the light adjusting [signal] to prevent the occurrence of brightness fluctuation.

### FIG. 1

1 INPUT VOLTAGE
2 FULL BRIDGE CIRCUIT
3 LOW-PASS FILTER
4 PIEZOELECTRIC TRANSFORMER
5 FULL BRIDGE DRIVE CIRCUIT
6 DUTY VARIABLE CIRCUIT
7 CURRENT/VOLTAGE CONVERSION CIRCUIT
8 INTEGRATOR (INCORPORATED WITH REFERENCE VOLTAGE)
9 VOLTAGE CONTROL TYPE OSCILLATOR
11 RISE DELAY CIRCUIT
22 PEAK VALUE CONTROL CIRCUIT (1−cosωt WAVEFORM)

### FIG. 2

DETAIL VIEW OF A RISE
PEAK VALUE CONTROL CIRCUIT
DUTY VARIABLE CIRCUIT
OUTPUT WAVEFORM
FULL BRIDGE CIRCUIT OUTPUT VOLTAGE
ω IS SET AT APPROXIMATELY f=ω/2π≅500 Hz
DETAIL VIEW OF A FALL
PEAK VALUE CONTROL CIRCUIT
DUTY VARIABLE CIRCUIT
OUTPUT WAVEFORM
FULL BRIDGE CIRCUIT OUTPUT VOLTAGE
ω IS SET AT APPROXIMATELY f=ω/2π≅500 Hz

### FIG. 3

LIGHT ADJUSTING SIGNAL
RISE DELAY CIRCUIT OUTPUT
PEAK VALUE CONTROL CIRCUIT
DUTY OF FULL BRIDGE CIRCUIT
OUTPUT CURRENT
VOLTAGE-CONVERTED VALUE OF OUTPUT CURRENT
REGION WHERE INTEGRATOR INTEGRATES VIV
REGION WHERE INTEGRATOR HALTS ITS OPERATION AND HOLDS ITS OUTPUT
IMMEDIATELY BEFORE THE HALT

### FIG. 4

1 INPUT VOLTAGE
2 FULL BRIDGE CIRCUIT
3 LOW-PASS FILTER
4 PIEZOELECTRIC TRANSFORMER
5 FULL BRIDGE DRIVE CIRCUIT
6 DUTY VARIABLE CIRCUIT
7 CURRENT/VOLTAGE CONVERSION CIRCUIT
8 INTEGRATOR (INCORPORATED WITH REFERENCE VOLTAGE)
9 VOLTAGE CONTROL TYPE OSCILLATOR
11 RISE DELAY CIRCUIT
21 CHOPPING CIRCUIT
22 PEAK VALUE CONTROL CIRCUIT (1−cosωt WAVEFORM)

### FIG. 5

DETAIL VIEW OF A RISE
PEAK VALUE CONTROL CIRCUIT
DUTY VARIABLE CIRCUIT
OUTPUT WAVEFORM
CHOPPING CIRCUIT OUTPUT VOLTAGE
ω IS SET AT APPROXIMATELY f=ω/2π≅500 Hz
DETAIL VIEW OF A FALL
PEAK VALUE CONTROL CIRCUIT
DUTY VARIABLE CIRCUIT
OUTPUT WAVEFORM
CHOPPING CIRCUIT OUTPUT VOLTAGE
ωIS SET AT APPROXIMATELY f=ω/2π≅500 Hz

### FIG. 6

LIGHT ADJUSTING SIGNAL
RISE DELAY CIRCUIT OUTPUT
PEAK VALUE CONTROL CIRCUIT
DUTY OF CHOPPING CIRCUIT
OUTPUT CURRENT
VOLTAGE-CONVERTED VALUE OF OUTPUT CURRENT
REGION WHERE INTEGRATOR INTEGRATES VIV
REGION WHERE INTEGRATOR HALTS ITS OPERATION AND HOLDS ITS OUTPUT
IMMEDIATELY BEFORE THE HALT

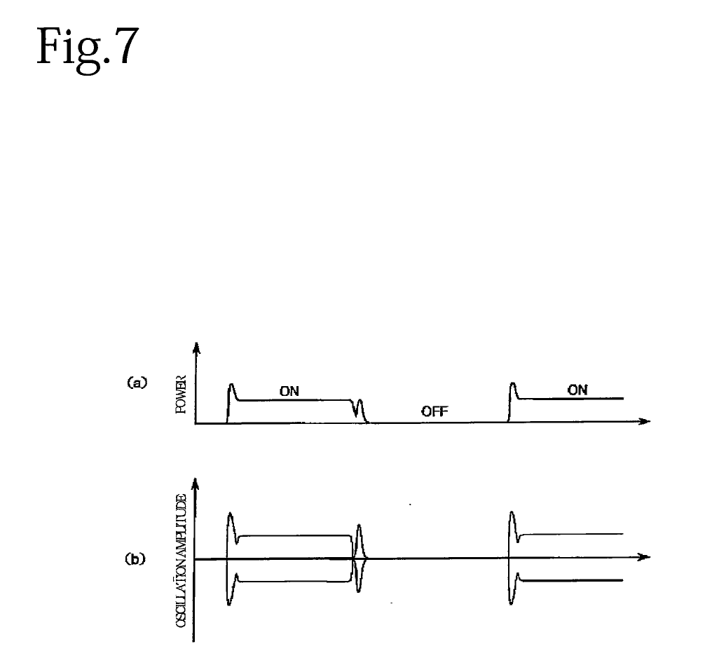

### FIG. 7

POWER
OSCILLATION AMPLITUDE

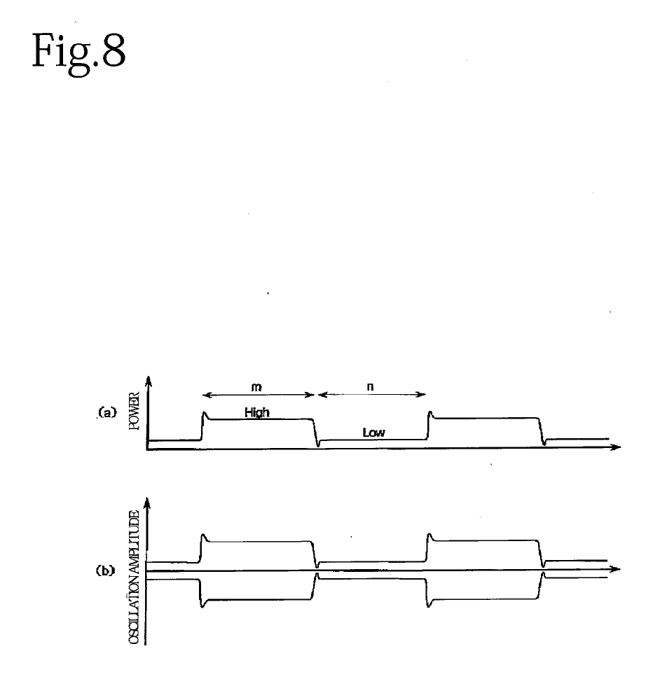

### FIG. 8

POWER
OSCILLATION AMPLITUDE

### FIG. 9

1 INPUT VOLTAGE
2 FULL BRIDGE CIRCUIT
3 LOW-PASS FILTER
4 PIEZOELECTRIC TRANSFORMER
5 FULL BRIDGE DRIVE CIRCUIT
6 DUTY VARIABLE CIRCUIT
7 CURRENT/VOLTAGE CONVERSION CIRCUIT
8 INTEGRATOR (INCORPORATED WITH REFERENCE VOLTAGE)
9 VOLTAGE CONTROL TYPE OSCILLATOR
10 TRAPEZOIDAL WAVE GENERATOR
11 RISE DELAY CIRCUIT

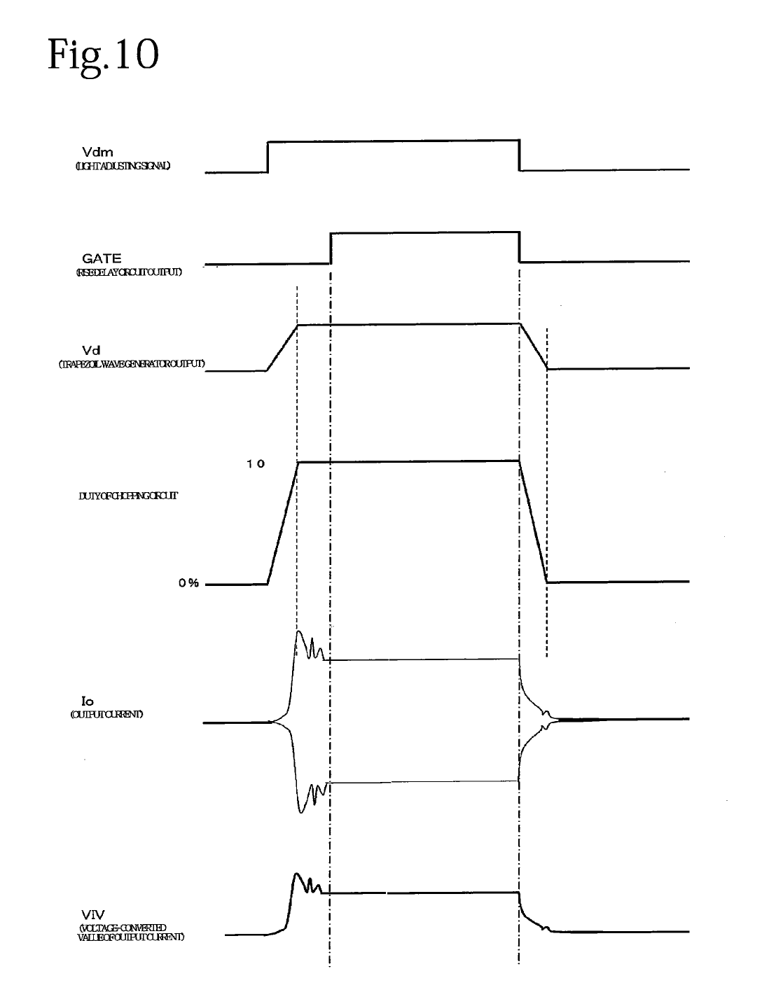

### FIG. 10

LIGHT ADJUSTING SIGNAL
RISE DELAY CIRCUIT OUTPUT
TRAPEZOIDAL WAVE GENERATOR OUTPUT
DUTY OF FULL BRIDGE CIRCUIT
OUTPUT CURRENT
VOLTAGE-CONVERTED VALUE OF OUTPUT CURRENT

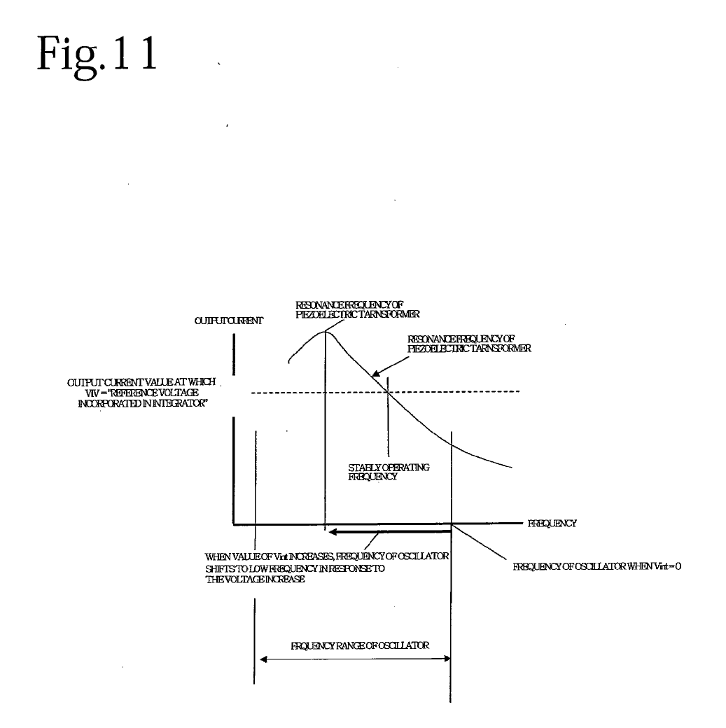

### FIG. 11

OUTPUT CURRENT
RESONANCE FREQUENCY OF PIEZOELECTRIC TRANSFORMER
RESONANCE FREQUENCY OF PIEZOELECTRIC TRANSFORMER
OUTPUT CURRENT VALUE AT WHICH VIV=“REFERENCE VOLTAGE INCORPORATED IN INTEGRATOR”
STABLY OPERATING FREQUENCY
FREQUENCY
WHEN VALUE OF Vint INCREASES, FREQUENCY OF OSCILLATOR SHIFTS TO LOW FREQUENCY IN RESPONSE TO THE VOLTAGE INCREASE
FREQUENCY RANGE OF OSCILLATOR
FREQUENCY OF OSCILLATOR WHEN Vint=0

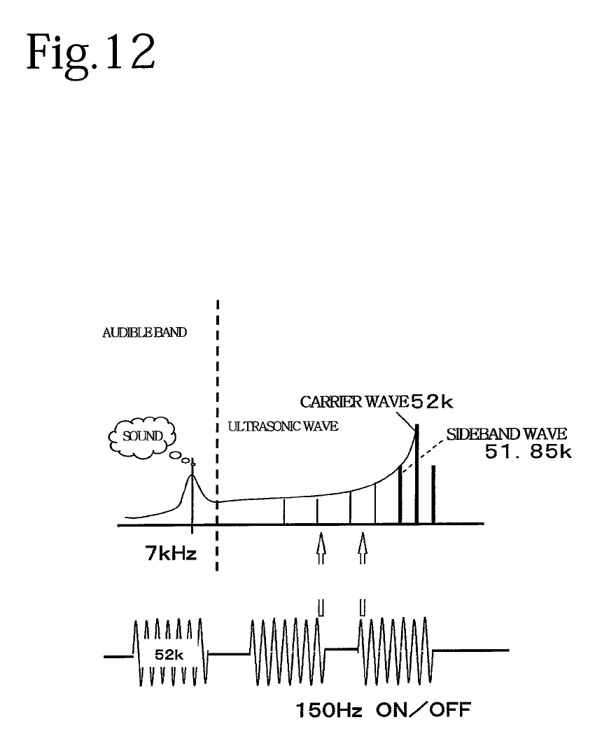

### FIG. 12

AUDIBLE BAND
SOUND
ULTRASONIC WAVE
CARRIER WAVE
SIDEBAND WAVE

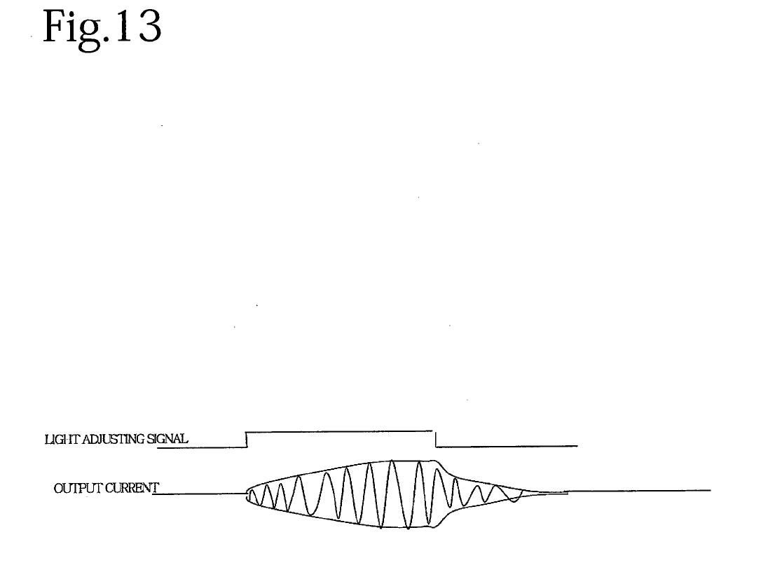

### FIG. 13

LIGHT ADJUSTING SIGNAL
OUTPUT CURRENT

1. A piezoelectric transformer light adjusting noise reduction circuit, which has a full bridge circuit that is activated by receiving an output voltage from an input voltage source, and a piezoelectric transformer that is supplied with an output from the full bridge circuit, and in which an output current of the piezoelectric transformer is supplied to a discharge tube, wherein
a full bridge drive circuit activated while feeding back a current flowing in a load is connected to the full bridge circuit,
a duty variable circuit that controls an output voltage output from the full bridge circuit is provided to either the full bridge circuit or full bridge drive circuit,
a peak value control circuit that controls a rising waveform and falling waveform of the output voltage of the full bridge circuit when a light adjusting signal rises and falls is connected to the duty variable circuit, and
the peak value control circuit controls a peak value of the output voltage of the full bridge circuit so that the rising waveform and falling waveform of the output voltage form cosine curves.

2. The piezoelectric transformer light adjusting noise reduction circuit according to claim 1, wherein an output of the peak value control circuit is connected to the duty variable circuit, and the full bridge drive circuit controls a duty of the full bridge circuit based on an output from the duty variable circuit.

3. The piezoelectric transformer light adjusting noise reduction circuit according to claim 1, wherein
the full bridge circuit is configured to have a fixed duty,
a chopping circuit that turns an output from the input voltage source ON/OFF in a predetermined cycle and changes an input voltage of the full bridge circuit is provided between the input voltage source and the full bridge circuit, and
the duty variable circuit that controls a duty [of the chopping circuit] and changes the output voltage is connected to the chopping circuit.

4. The piezoelectric transformer light adjusting noise reduction circuit according to claim 1, wherein the full bridge drive circuit is connected to a current/voltage conversion circuit for detecting the current flowing in the load and converting the same to a voltage value, an integrator for comparing a load current acquired by the current/voltage conversion circuit with a reference voltage incorporated [in the integrator], and to a voltage control type oscillator for determining an oscillating frequency based on an output from the integrator, and wherein an output from the voltage control type oscillator is fed back to the full bridge circuit via the full bridge drive circuit to control an operating frequency of the full bridge circuit.

5. The piezoelectric transformer light adjusting noise reduction circuit according to claim 4, wherein the integrator is provided with a rise delay circuit for prohibiting the operation of the integrator in order to secure a transient response of a rise of the output current and a period during which the duty variable circuit performs soft starting.
